(19) United States
(12) Patent Application Publication
(10) Pub. No.: US 2025/0350324 A1
(43) Pub. Date: Nov. 13, 2025

(54) FAST BEAM SWEEPING FOR L3 MEASUREMENT

(71) Applicant: QUALCOMM Incorporated, San Diego, CA (US)

(72) Inventors: Hyunwoo CHO, San Diego, CA (US); Changhwan PARK, San Diego, CA (US)

(21) Appl. No.: 19/182,424

(22) Filed: Apr. 17, 2025

Related U.S. Application Data
(60) Provisional application No. 63/645,773, filed on May 10, 2024.

(51) Int. Cl. H04B 7/0408

(52) U.S. Cl. CPC H04B 7/0408

(57) ABSTRACT

Apparatus, methods, and computer program products for wireless communication are provided. An example method may include transmitting, to a network node, an indication to perform a simultaneous multi-beam reception from a network layer for a beam sweeping. The example method may further include receiving, from the network node, at least one fallback threshold for a deactivation associated with the simultaneous multi-beam reception. The example method may further include performing the simultaneous multi-beam reception from the network layer for the beam sweeping.

### CROSS REFERENCE TO RELATED APPLICATION(S)

This application claims the benefit of and priority to U.S. Provisional Application Ser. No. 63/645,773, entitled “FAST BEAM SWEEPING FOR L3 MEASUREMENT” and filed on May 10, 2024, which is expressly incorporated by reference herein in its entirety.

### TECHNICAL FIELD

The present disclosure relates generally to communication systems, and more particularly, to wireless communication systems with beam sweeping.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor is configured to (e.g., configured to cause the UE to) transmit, to a network node, an indication to perform a simultaneous multi-beam reception from a network layer for a beam sweeping. Based at least in part on information stored in the at least one memory, the at least one processor is configured to receive, from the network node, at least one fallback threshold for a deactivation associated with the simultaneous multi-beam reception. Based at least in part on information stored in the at least one memory, the at least one processor is configured to perform the simultaneous multi-beam reception from the network layer for the beam sweeping.

In another aspect of the disclosure, a method, a computer-readable medium, and an apparatus at a network node are provided. The apparatus may include at least one memory and at least one processor coupled to the at least one memory. Based at least in part on information stored in the at least one memory, the at least one processor is configured to (e.g., configured to cause the network node to) receive, from UE, an indication to perform a simultaneous multi-beam reception from a network layer for a beam sweeping. Based at least in part on information stored in the at least one memory, the at least one processor is configured to transmit, for the UE, at least one fallback threshold for a deactivation associated with the simultaneous multi-beam reception.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a network node in communication with a UE.

FIG. 5 is a diagram illustrating an example of beam sweeping without multi reception and with multi-reception.

FIG. 6 is a diagram illustrating an example of a UE, a serving cell, and a neighbor cell, where the UE may not perform fast beam sweeping due to a current serving cell condition being good.

FIG. 7 is a diagram illustrating an example of communications related to beam management between a UE and a network.

FIG. 8 is a diagram illustrating an example of threshold condition(s) for fallback.

FIG. 9 is a diagram illustrating an example measurements related to fast beam sweeping and fallback.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. The one or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

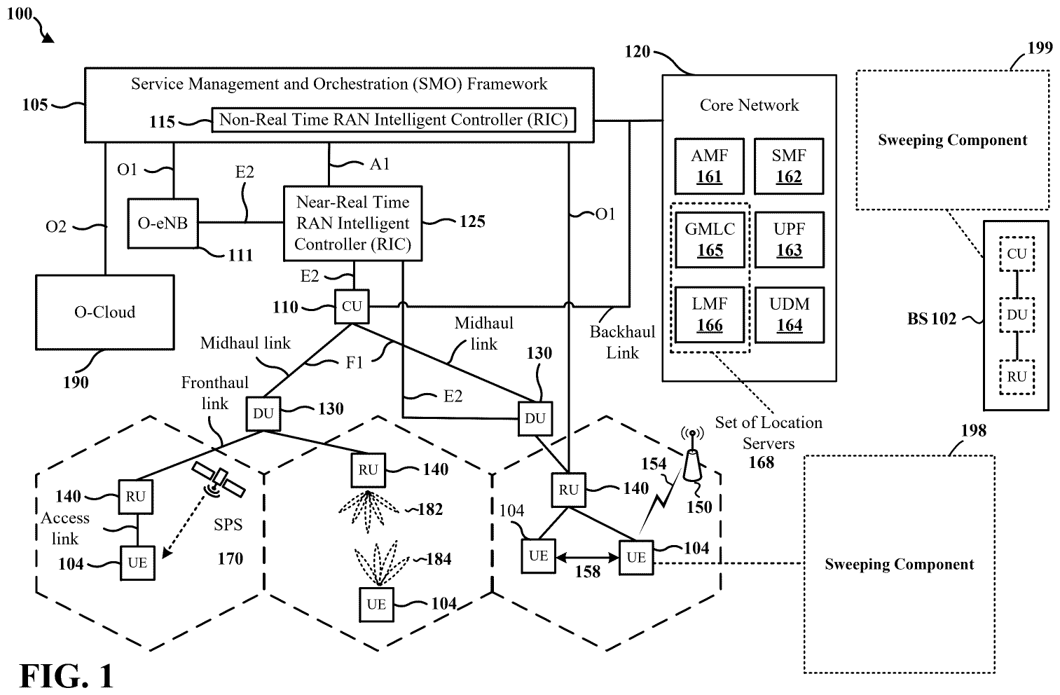

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a sweeping component 198. In some aspects, the sweeping component 198 may be configured to transmit, to a network node, an indication to perform a simultaneous multi-beam reception from a network layer for a beam sweeping. In some aspects, the sweeping component 198 may be further configured to receive, from the network node, at least one fallback threshold for a deactivation associated with the simultaneous multi-beam reception. In some aspects, the sweeping component 198 may be further configured to perform the simultaneous multi-beam reception from the network layer for the beam sweeping.

In some aspects, the base station 102 may include a sweeping component 199. In some aspects, the sweeping component 199 may be configured to receive, from a UE, an indication to perform a simultaneous multi-beam reception from a network layer for a beam sweeping. In some aspects, the sweeping component 199 may be configured to transmit, for the UE, at least one fallback threshold for a deactivation associated with the simultaneous multi-beam reception.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

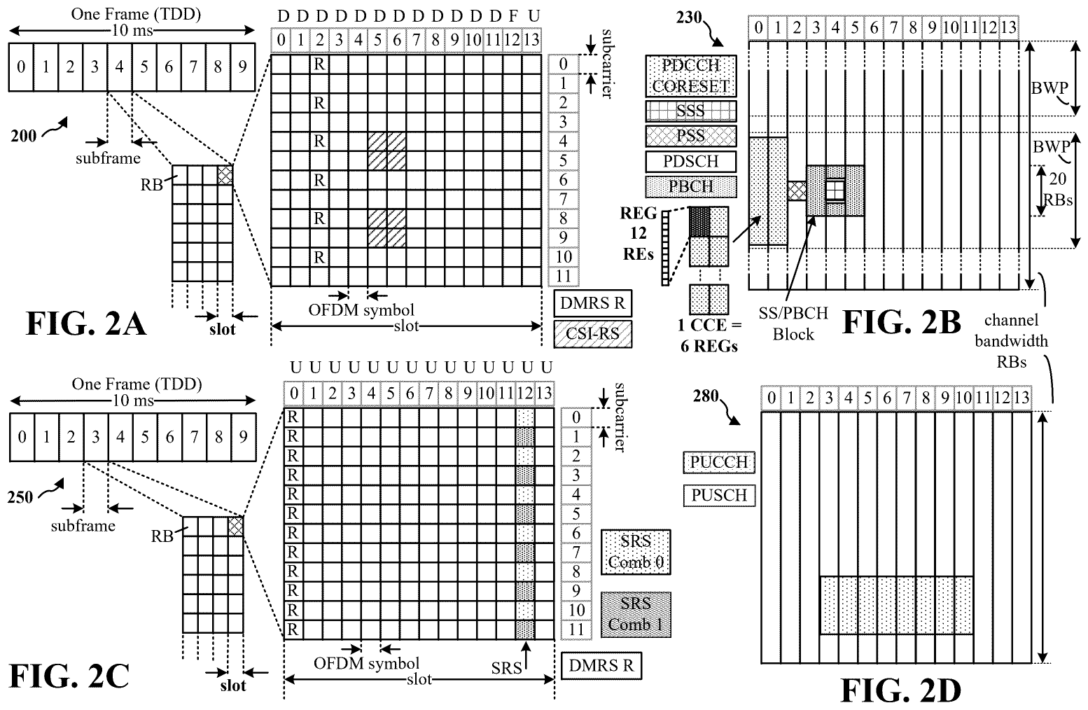

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

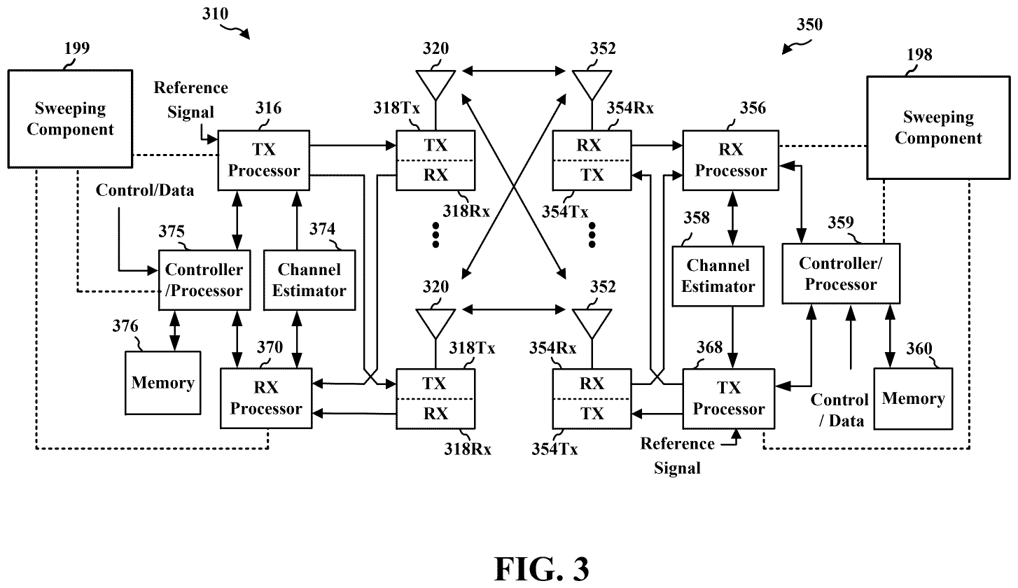

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with sweeping component 198 of FIG. 1.

At least one of the TX processor 316, the RX processor 370, and the controller/processor 375 may be configured to perform aspects in connection with sweeping component 199 of FIG. 1.

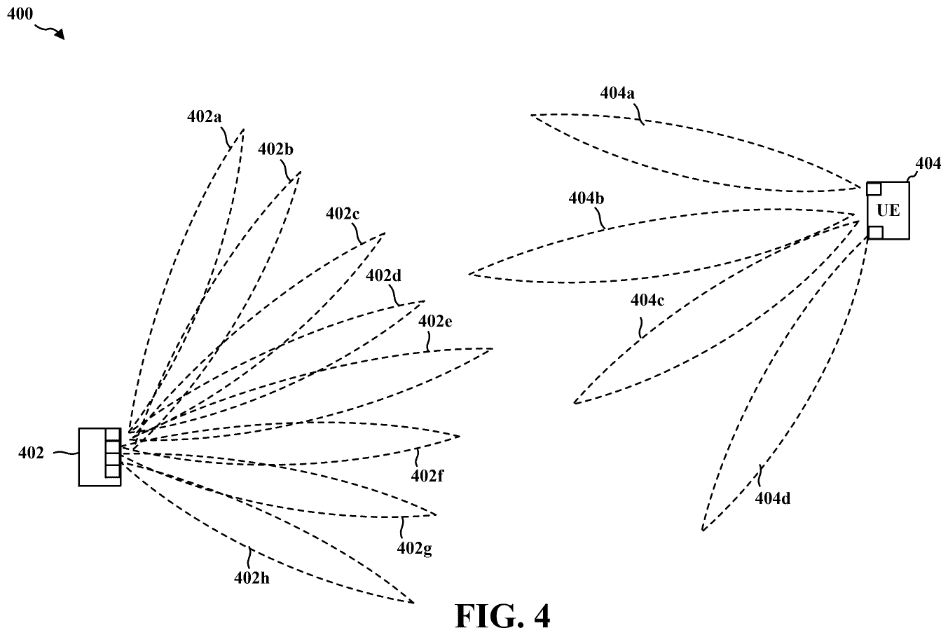

FIG. 4 is a diagram 400 illustrating a network node 402 in communication with a UE 404. Referring to FIG. 4, the network node 402 may transmit a beamformed signal to the UE 404 in one or more of the directions 402a, 402b, 402c, 402d, 402e, 402f, 402g, 402h. The UE 404 may receive the beamformed signal from the network node 402 in one or more receive directions 404a, 404b, 404c, 404d. The UE 404 may also transmit a beamformed signal to the network node 402 in one or more of the directions 404a-404d. The network node 402 may receive the beamformed signal from the UE 404 in one or more of the receive directions 402a-402h. The network node 402/UE 404 may perform beam training to determine the best receive and transmit directions for each of the network node 402/UE 404. The transmit and receive directions for the network node 402 may or may not be the same. The transmit and receive directions for the UE 404 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 404 may determine to switch beams, e.g., between beams 402a-402h. The beam at the UE 404 may be used for reception of downlink communication and/or transmission of uplink communication. In some examples, the network node 402 may send a transmission that triggers a beam switch by the UE 404. A transmission configuration indicator (TCI) state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the network node 402 may indicate a TCI state change, and in response, the UE 404 may switch to a new beam (which may be otherwise referred to as performing a beam switch) according to the new TCI state indicated by the network node 402.

One type of beamforming may include codebook-based beam scanning. A codebook may include information corresponding to a beam used for communication, such as a beam index, direction, beam weights across antennas, antenna ordering information, beam steering information (e.g., angles in azimuth and/or zenith), and/or other information associated with a beam. For example, a codebook may include a collection of beamforming vectors (e.g., fixed or predefined beamforming vectors), as well as techniques for generating and/or combining vectors (both static as well as dynamic). Beamforming codebooks may be either designed for rank-1 analog beamforming or for higher rank precoding applications. An example of a codebook may include a matrix of beam weights with different column vectors corresponding to the weights used across different antennas for a certain layer of data transmission.

Another type of beamforming may be non-codebook based, which may be referred to as “dynamic beamforming.” For dynamic beamforming in uplink, SRS may be sent from UE to the RU, and the RU may transmit raw SRS samples to DU so that the DU may perform spatial processing on these samples and compute beamforming weights, which may also be referred to as “beam weights.”

A UE may report various metrics with regard to at least one beam. For example, the metrics may include reference signal received power (RSRP), signal to interference and noise ratio (SINR), rank indicator (RI), precoding matrix indicator (PMI), channel quality indicator (CQI), or other metrics with regard to at least one beam. A transmission carrying the metrics with regard to a beam may be referred to as a “beam report.”

In some aspects, for UEs supporting multiple-Rx simultaneous reception on single carrier, to reduce network layer (layer 3 (L3)) measurement delay, Rx beam sweeping factor may be optimized. As used herein, the term “a simultaneous multi-beam reception from a network layer for beam sweeping” may refer to an L3 beam sweeping where the UE can simultaneously receive different directions of beam from target cell. Such beam sweeping may also be referred to as “fast beam sweeping.” As an example, a UE may perform fast beam sweeping for L3 measurement when the UE is in multi-Rx operation and may support beam sweeping factor reduction for SSB-based layer-3 measurement for activated serving cell when the UE is in multi-Rx operation.

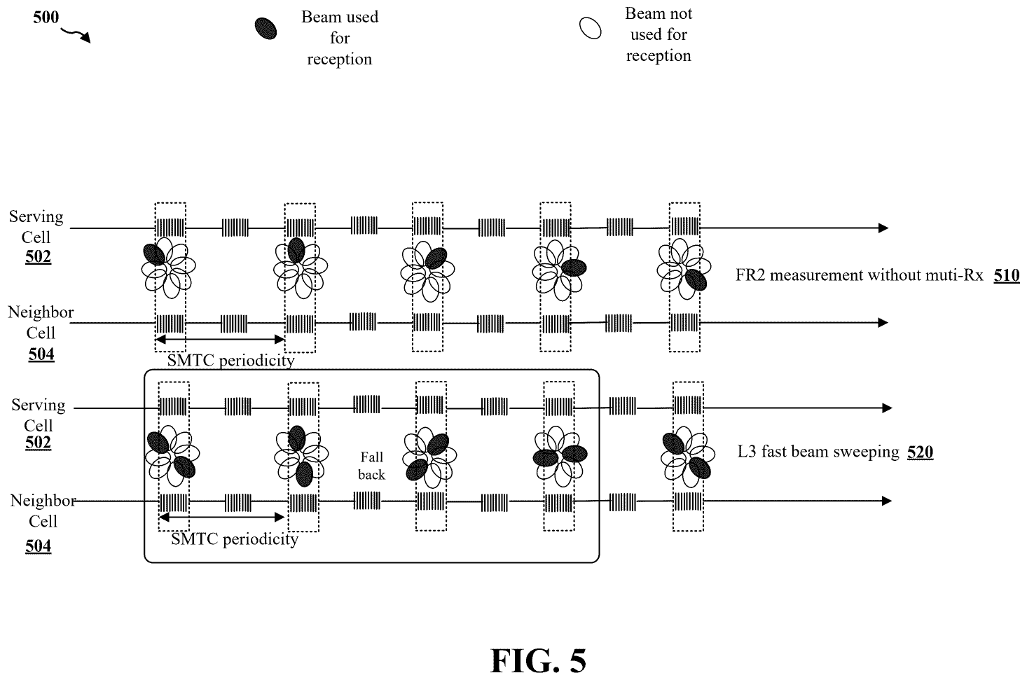

Using multi-panel with simultaneous reception can enable UE to receive different direction of beams from neighbor cell. Effectively, such a scenario may reduce overall measurement delay. A measurement cycle in such a scenario where multi-Rx is used for L3 measurement may be 50% faster than a measurement cycle without multi-Rx. For example, for inter-frequency measurement delay, 8 measurement cycle (samples) for power class 1 or 5 may be used and 5 measurement cycles for power class 2, 3, 4 for FR2-1 may be used. FIG. 5 is a diagram 500 illustrating an example of beam sweeping without multi reception and with multi-reception. As illustrated in FIG. 5, each beam may correspond to a panel at a UE, which may be pointing to different directions. Without multi-reception, at 510, the UE's reception may be based on a single beam and a single direction, where the UE may change the beam and the direction (e.g., in accordance with a synchronization signal/physical broadcast channel (SS/PBCH) block measurement timing configuration (SMTC) periodicity). With multi-reception, at 520, the UE's reception may be based on multiple beams and multiple directions and the UE may be able to receive from serving cell 502 and neighbor cell 504, which may allow reduction of overall measurement delay.

In some scenarios, fast beam sweeping for L3 may be not used. Aspects provided herein relate to how to configure, trigger, or deactivate L3 beam sweeping. Fast beam sweeping for L3 neighbor cell measurement may have very high power consumption from multi-Rx simultaneous operation. Therefore, aspects provided herein may reduce power consumption at the UE by more efficiently trigger or deactivate L3 beam sweeping. Fast beam sweeping for L3 measurement may be controlled by UE and network.

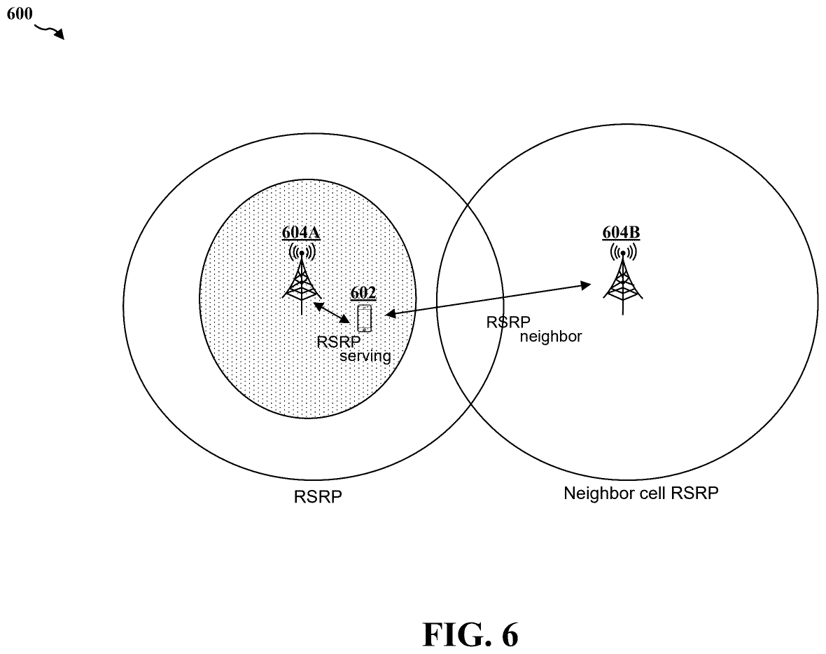

FIG. 6 is a diagram 600 illustrating an example of a UE, a serving cell, and a neighbor cell, where the UE may not perform fast beam sweeping due to a current serving cell condition being good. As illustrated in FIG. 6, when current serving cell 604A's condition is good (e.g., based on RSRP associated with the current serving cell 604A being above a threshold), the UE 602 may not perform fast L3 measurement for neighbor cell 604B.

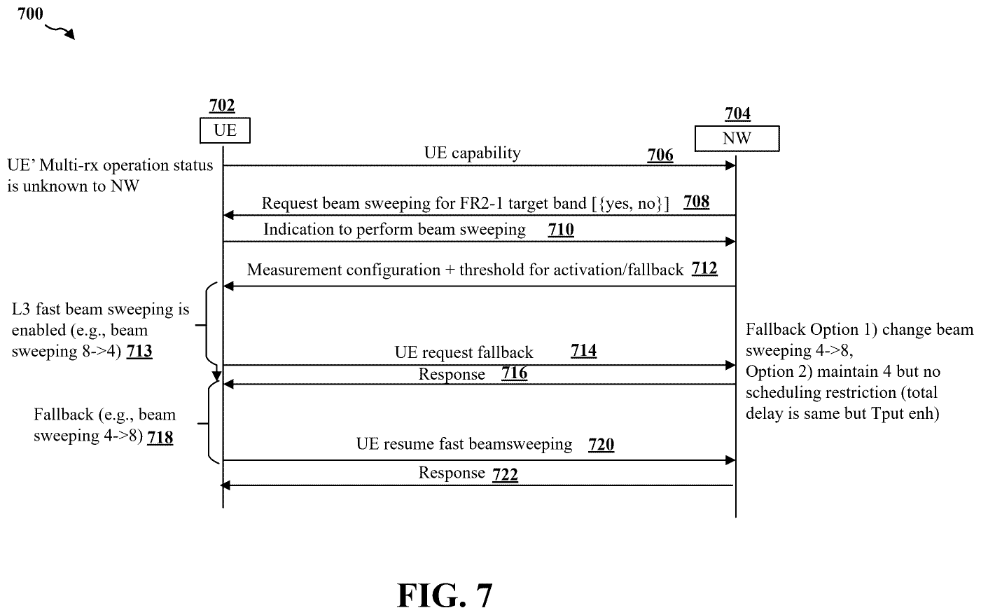

FIG. 7 is a diagram 700 illustrating an example of communications related to beam management between a UE and a network. As illustrated in FIG. 7, the UE 702 may transmit, to the network 704, a UE capability 706 which indicates that the UE 702 supports L3 fast beam sweeping (simultaneous multi-beam reception from a network layer for beam sweeping). In some aspects, the network 704 may transmit a request to perform L3 fast beam sweeping 708, and the UE 702 may accordingly respond with an indication to L3 fast perform beam sweeping 710. In some aspects, instead of receiving a request, the UE 702 may directly transmit the indication to L3 fast perform beam sweeping 710 to the network 704.

In some aspects, based on receiving the indication to L3 fast perform beam sweeping 710 from the UE 702, the network 704 may transmit a measurement configuration and threshold(s) for activation/fallback (deactivation) of the L3 fast beam sweeping 712. In some aspects, the measurement configuration and threshold(s) for activation/fallback (deactivation) of the L3 fast beam sweeping may include at least one fallback threshold and at least one activation threshold. The at least one fallback threshold may define condition(s) in which the UE 702 may deactivate L3 fast beam sweeping, and the at least one activation threshold may define condition(s) in which the UE 702 may activate L3 fast beam sweeping. In some aspects, the threshold(s) may be used for or may be based on (1) comparing serving cell and neighbor cell RSRP, (2) evaluate serving cell conditions, or (3) evaluate neighbor cell conditions. In some aspects, the at least one fallback threshold may include a threshold such that the UE may start the fallback procedure based on: RSRP_{serving}−RSRP_{neighbor}>=Threshold₁. In some aspects, the at least one fallback threshold may include a threshold such that the UE may start the fallback procedure based on: RSRP_{serving}>=Threshold₂. In some aspects, the at least one fallback threshold may include a threshold such that the UE may start the fallback procedure based on RSRP_{neighbor}<=Threshold₃. These different thresholds and conditions may be used for fallback from fast beam sweeping. In some aspects, the fallback threshold(s) is configured by network (e.g., via radio resource control (RRC)). In some aspects, a reverse of the fallback threshold(s) may be the activation threshold(s). In some aspects, the activation threshold(s) may include RSRP_{serving}−RSRP_{neighbor}<Threshold₁. In some aspects, the activation threshold(s) may include RSRP_{serving}<Threshold₂. In some aspects, the activation threshold(s) may include RSRP_{neighbor}<Threshold₃. In some aspects, the activation threshold(s) or the fallback threshold(s) may be based on evaluation of various measurement metric(s) such as RSRP, received signal strength indicator (RSSI), signal to interference and noise ratio (SINR), or the like.

In some aspects, after receiving the measurement configuration and threshold(s) for activation/fallback (deactivation) of the L3 fast beam sweeping 712, the UE 702 may perform L3 fast beam sweeping at 713 (e.g., 8->4 beam scaling factor, changing beam scaling factor from eight to four), which may be based on the at least one activation threshold. In some aspects, based on the at least one fallback threshold, the UE 702 may deactivate the L3 fast beam sweeping and initiate fallback at 718 (e.g., 4->8 beam scaling factor, changing beam scaling factor from four to eight). In some aspects, based on the at least one fallback threshold, the UE 702 may transmit a fallback request 714 and receive a response 716 from the network 704 before deactivating the L3 fast beam sweeping and initiating fallback at 718. In some aspects, as a different fallback procedure at 718, the UE 702 may maintain the beam scaling factor but change a scheduling restriction. Depending on channel condition from UE's location, UE may fallback to either (1) FR2 measurement without multi-Rx or (2) skipping SMTC while keeping reduced beam sweeping factor. Both options may have a same measurement delay. However, for skipping SMTC while keeping reduced beam sweeping factor, the UE may obtain Tput gain because no scheduling restriction around SSB symbol in skipped SMTC.

In some aspects, based on the activation threshold(s) being met again (e.g., which may correspond to the fallback threshold(s) being no longer met), the UE 702 may resume L3 fast beam sweeping at 720, which may be indicated to the network 704. In some aspects, the network 704 may respond with a response 722 after receiving the indication at 720 but before the UE resumes L3 fast beam sweeping (e.g., the UE may resume L3 fast beam sweeping after receiving the response 722). In some aspects, the network 704 may not transmit the response 722.

In some aspects, for a UE that supports L3 fast beam sweeping (simultaneous multi-beam reception from a network layer for beam sweeping), as a first step, the network may request whether UE can perform fast beam sweeping for L3. As a second step, the UE responds. If yes, UE operates fast beam sweeping for L3 (e.g., 8->4 beam scaling factor) until UE initiate fallback process. If the response is no, FR2 measurement without multi-Rx may be applied. As a third step, the network may NW configure threshold for fallback (e.g., which corresponds to deactivation of the simultaneous multi-beam reception from a network layer for beam sweeping). The threshold may be used for (1) comparing serving cell and neighbor cell RSRP, (2) evaluate serving cell conditions, or (3) evaluate neighbor cell conditions. The fallback threshold may be used for starting a “fallback procedure,” which may include (1) change beam sweeping factor, or (2) skipping of a synchronization signal/physical broadcast channel (SS/PBCH) block measurement timing configuration (SMTC). As a fourth step, depends on measurement metric (e.g., reference signal received power (RSRP), received signal strength indicator (RSSI), signal to interference and noise ratio (SINR), or the like) evaluation, UE can initiate fallback procedure such as (1) fallback request (e.g., 4->8 beam scaling factor), or (2) SMTC skipping (e.g., keep 4 beam sweeping factor but skip SMTC). As a fifth step, depends on measurement metric evaluation, UE may initiate resuming fast beam sweeping (SMTC skipping is disabled if configured).

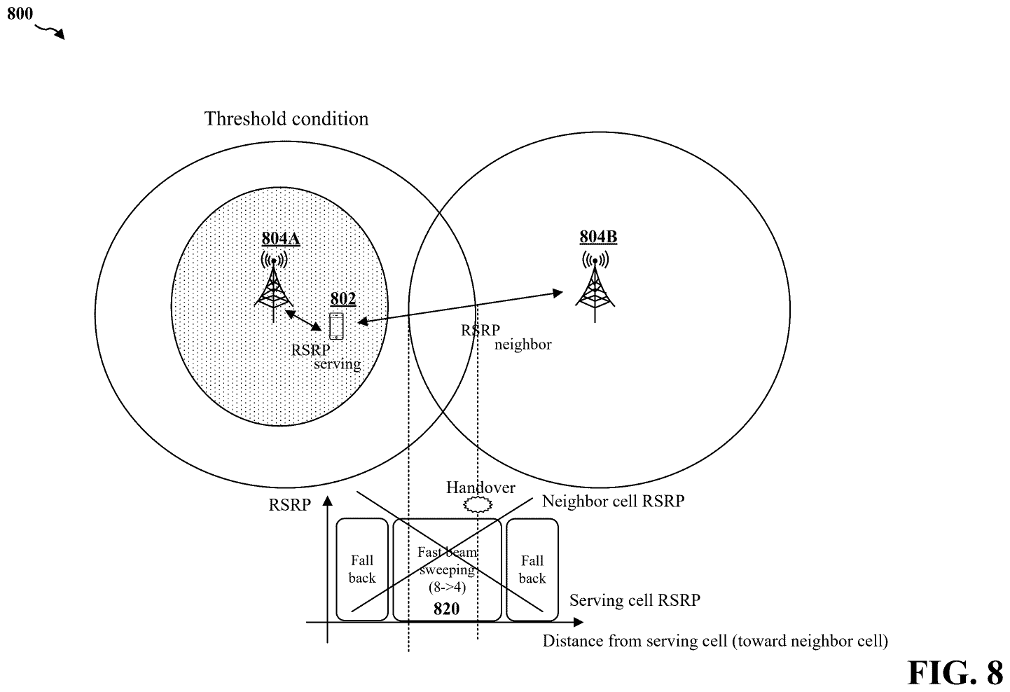

FIG. 8 is a diagram 800 illustrating an example of threshold condition(s) for fallback. As illustrated in FIG. 8, as the UE 802 moves and the distances between the UE 802 a serving cell 804A/a neighbor cell 804B changes, the UE 802 may measure RSRP associated with the serving cell 804A and the neighbor cell 804B to determine whether fast beam sweeping 820 may be activated.

In some aspects, the fallback threshold may include a threshold such that the UE may start the fallback procedure based on: RSRP_{serving}−RSRP_{neighbor}>=Threshold₁. In some aspects, the fallback threshold may include a threshold such that the UE may start the fallback procedure based on: RSRP_{serving}>=Threshold₂. In some aspects, the fallback threshold may include a threshold such that the UE may start the fallback procedure based on RSRP_{neighbor}<=Threshold₃. These different thresholds and conditions may be used for fallback from fast beam sweeping. In some aspects, the fallback threshold(s) is configured by network. If UE fulfilled the threshold condition (e.g., one of the threshold conditions), the UE may request fallback in the form of beam sweeping factor reduction or the UE may request SMTC skipping with or without fallback. In some aspects, after UE initiate fallback, and conditions are not fulfilled, the UE may initiate resume of fast beam sweeping.

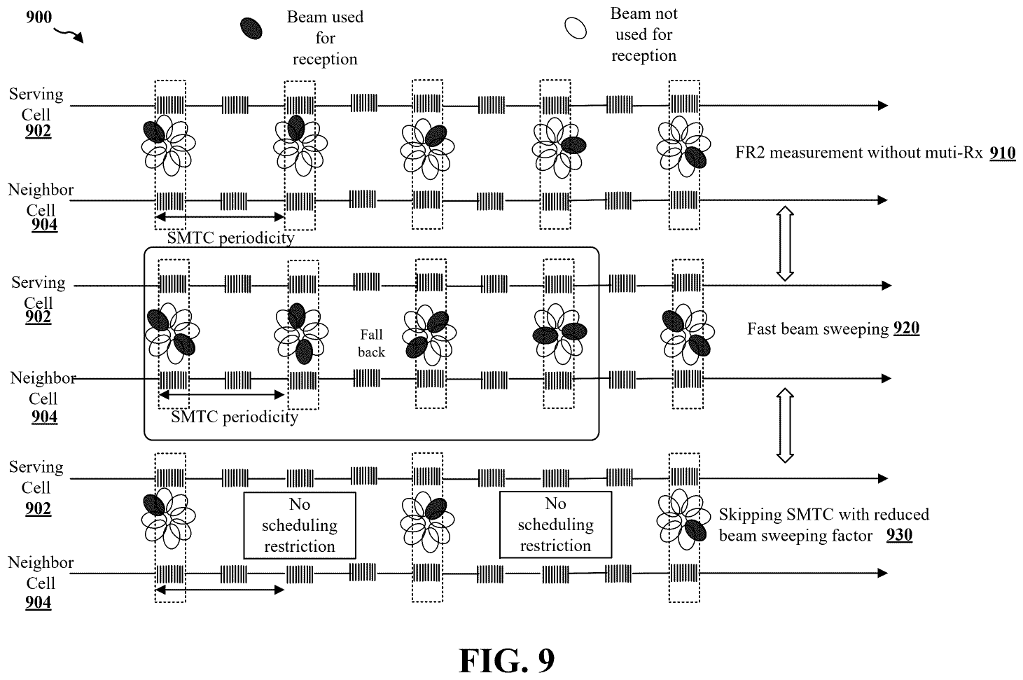

FIG. 9 is a diagram 900 illustrating an example measurements related to fast beam sweeping and fallback. Without multi-reception, at 910, the UE's reception may be based on a single beam and a single direction, where the UE may change the beam and the direction (e.g., in accordance with a SMTC periodicity). With multi-reception, at 920, the UE's reception may be based on multiple beams and multiple directions and the UE may be able to receive from serving cell 902 and neighbor cell 904, which may allow reduction of overall measurement delay. In a third scenario 930 where the UE may be skipping SMTC with reduced beam sweeping factor, the UE may be subject to no scheduling restriction around SSB symbol in skipped SMTC and the UE may obtain throughput gain accordingly.

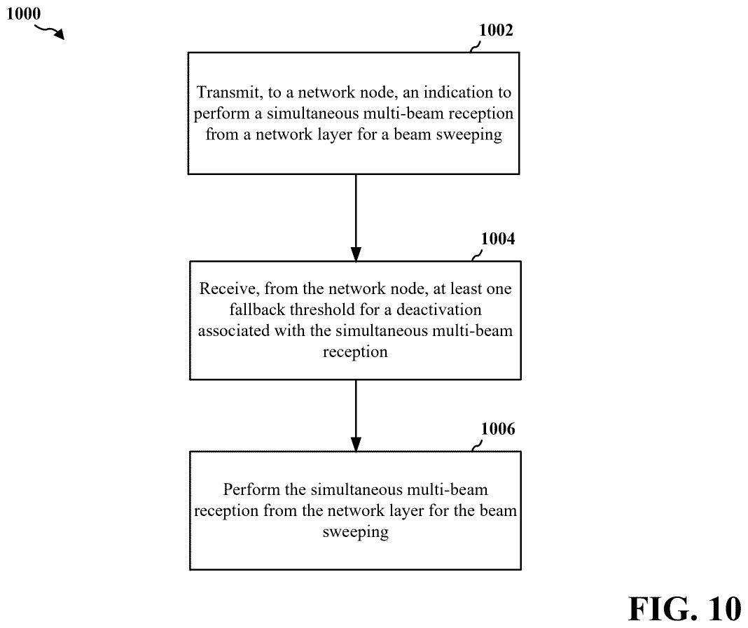

FIG. 10 is a flowchart 1000 of a method of wireless communication. The method may be performed by a UE (e.g., the UE 104, the UE 702, the apparatus 1204).

At 1002, the UE may transmit, to a network node, an indication to perform a simultaneous multi-beam reception from a network layer for a beam sweeping. In some aspects, 1002 may be performed by sweeping component 198. For example, the UE 702 may transmit, to a network node (e.g., 704), an indication (e.g., 710) to perform a simultaneous multi-beam reception from a network layer for a beam sweeping.

At 1004, the UE may receive, from the network node, at least one fallback threshold for a deactivation associated with the simultaneous multi-beam reception. In some aspects, 1004 may be performed by sweeping component 198. For example, the UE 702 may receive, from the network node (e.g., 704), at least one fallback threshold (e.g., 712) for a deactivation associated with the simultaneous multi-beam reception.

At 1006, the UE may perform the simultaneous multi-beam reception from the network layer for the beam sweeping. In some aspects, 1006 may be performed by sweeping component 198. For example, the UE 702 may perform (e.g., at 713) the simultaneous multi-beam reception from the network layer for the beam sweeping.

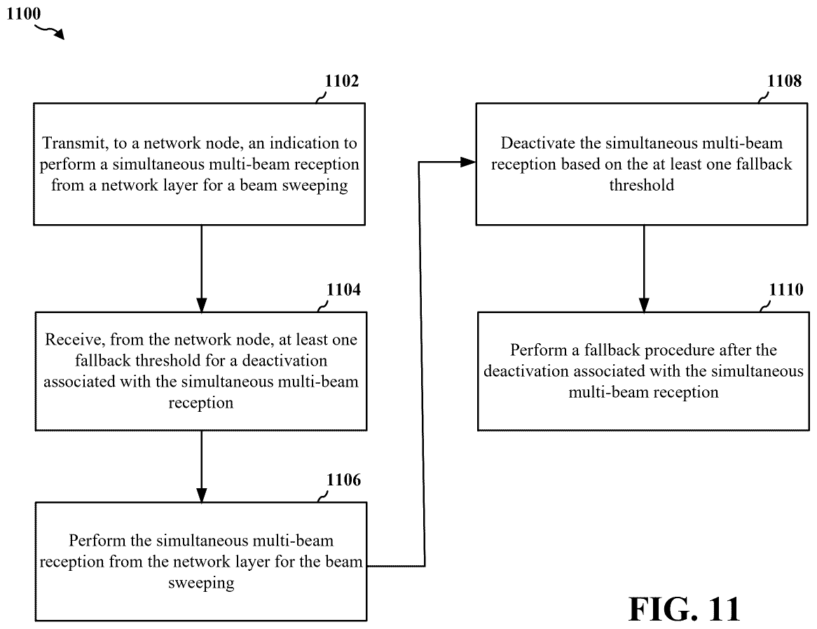

FIG. 11 is a flowchart 1100 of a method of wireless communication. The method may be performed by a UE (e.g., the UE 104, the UE 702, the apparatus 1204).

At 1102, the UE may transmit, to a network node, an indication to perform a simultaneous multi-beam reception from a network layer for a beam sweeping. In some aspects, 1102 may be performed by sweeping component 198. For example, the UE 702 may transmit, to a network node (e.g., 704), an indication (e.g., 710) to perform a simultaneous multi-beam reception from a network layer for a beam sweeping.

At 1104, the UE may receive, from the network node, at least one fallback threshold for a deactivation associated with the simultaneous multi-beam reception. In some aspects, 1104 may be performed by sweeping component 198. For example, the UE 702 may receive, from the network node (e.g., 704), at least one fallback threshold (e.g., 712) for a deactivation associated with the simultaneous multi-beam reception.

At 1106, the UE may perform the simultaneous multi-beam reception from the network layer for the beam sweeping. In some aspects, 1106 may be performed by sweeping component 198. For example, the UE 702 may perform (e.g., at 713) the simultaneous multi-beam reception from the network layer for the beam sweeping. In some aspects, the performance of the simultaneous multi-beam reception from the network layer for the beam sweeping may be based on an activation threshold.

At 1108, the UE may deactivate the simultaneous multi-beam reception based on the at least one fallback threshold. In some aspects, 1108 may be performed by sweeping component 198. For example, the UE 702 may deactivate (e.g., at 718) the simultaneous multi-beam reception based on the at least one fallback threshold.

At 1110, the UE may perform a fallback procedure after the deactivation associated with the simultaneous multi-beam reception. In some aspects, 1110 may be performed by sweeping component 198. For example, the UE 702 may perform (e.g., after 714) a fallback procedure (e.g., change beam scaling factor from four to eight or change scheduling restriction) after the deactivation associated with the simultaneous multi-beam reception.

In some aspects, the at least one fallback threshold includes a difference threshold. In some aspects, the UE may transmit, to the network node based on a difference between a first measurement for a serving cell and a second measurement for a neighbor cell associated with the beam sweeping being above the difference threshold, a request for the fallback procedure after the deactivation associated with the simultaneous multi-beam reception.

In some aspects, the at least one fallback threshold includes a serving cell threshold. In some aspects, the UE may transmit, to the network node based on a measurement for a serving cell being above the serving cell threshold, a request for the fallback procedure after the deactivation associated with the simultaneous multi-beam reception.

In some aspects, the at least one fallback threshold includes a neighbor cell threshold. In some aspects, the UE may transmit, to the network node based on a measurement for a neighbor cell associated with the beam sweeping being below the neighbor cell threshold, a request for the fallback procedure after the deactivation associated with the simultaneous multi-beam reception.

In some aspects, the UE may transmit, to the network node based on at least one measurement satisfying the at least one fallback threshold, the request for the fallback procedure. In some aspects, the UE may receive, from the network node, a response to the request for the fallback procedure.

In some aspects, the UE may transmit, to the network node based on the at least one measurement no longer satisfying the at least one fallback threshold, a second request for resuming the simultaneous multi-beam reception from the network layer for the beam sweeping. In some aspects, the UE may receive, from the network node, a second response to the second request.

In some aspects, the fallback procedure includes a reduction of a beam sweeping factor, and where the request for the fallback procedure or the response to the request for the fallback procedure includes a value associated with the reduction. In some aspects, the fallback procedure includes a skip of a synchronization signal/physical broadcast channel (SS/PBCH) block measurement timing configuration (SMTC). In some aspects, the beam sweeping corresponds to a layer 3 (L3) fast beam sweeping. In some aspects, the beam sweeping corresponds to a procedure including simultaneous reception of reference signals in different directions associated with a same target cell.

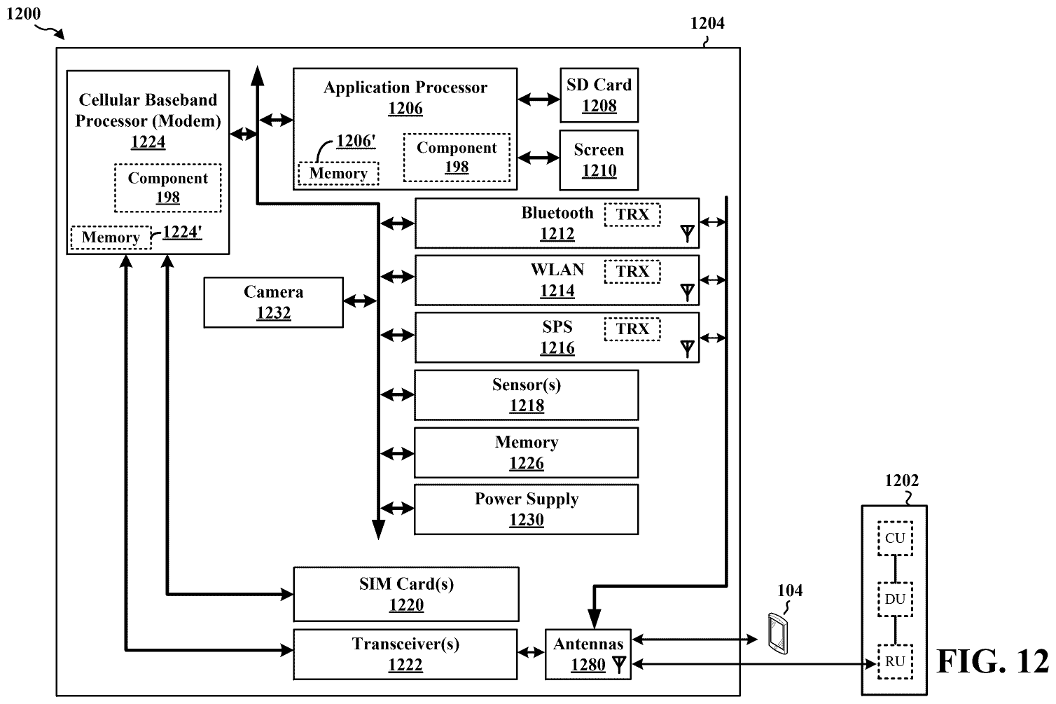

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the sweeping component 198 may be configured to transmit, to a network node, an indication to perform a simultaneous multi-beam reception from a network layer for a beam sweeping. In some aspects, the sweeping component 198 may be further configured to receive, from the network node, at least one fallback threshold for a deactivation associated with the simultaneous multi-beam reception. In some aspects, the sweeping component 198 may be further configured to perform the simultaneous multi-beam reception from the network layer for the beam sweeping. The sweeping component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for transmitting, to a network node, an indication to perform a simultaneous multi-beam reception from a network layer for a beam sweeping. In some aspects, the apparatus 1204 may include means for receiving, from the network node, at least one fallback threshold for a deactivation associated with the simultaneous multi-beam reception. In some aspects, the apparatus 1204 may include means for performing the simultaneous multi-beam reception from the network layer for the beam sweeping. In some aspects, the apparatus 1204 may include means for deactivating the simultaneous multi-beam reception based on the at least one fallback threshold. In some aspects, the apparatus 1204 may include means for performing a fallback procedure after the deactivation associated with the simultaneous multi-beam reception. In some aspects, the apparatus 1204 may include means for transmitting, to the network node based on a difference between a first measurement for a serving cell and a second measurement for a neighbor cell associated with the beam sweeping being above the difference threshold, a request for a fallback procedure after the deactivation associated with the simultaneous multi-beam reception. In some aspects, the apparatus 1204 may include means for transmitting, to the network node based on a measurement for a serving cell being above the serving cell threshold, a request for a fallback procedure after the deactivation associated with the simultaneous multi-beam reception. In some aspects, the apparatus 1204 may include means for transmitting, to the network node based on a measurement for a neighbor cell associated with the beam sweeping being below the neighbor cell threshold, a request for a fallback procedure after the deactivation associated with the simultaneous multi-beam reception. In some aspects, the apparatus 1204 may include means for transmitting, to the network node based on at least one measurement satisfying the at least one fallback threshold, a request for a fallback procedure after the deactivation associated with the simultaneous multi-beam reception. In some aspects, the apparatus 1204 may include means for receiving, from the network node, a response to the request for the fallback procedure. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

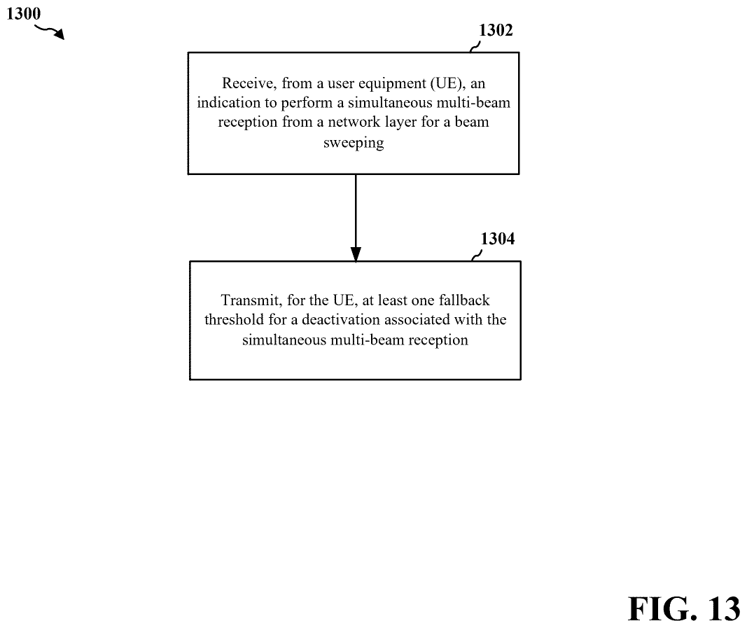

FIG. 13 is a flowchart 1300 of a method of wireless communication. The method may be performed by a network entity (e.g., the base station 102, the network 704, the network entity 1202, the network entity 1402).

At 1302, the network entity may receive, from a user equipment (UE), an indication to perform a simultaneous multi-beam reception from a network layer for a beam sweeping. For example, the network entity (e.g., 704) may receive, from a UE 702, an indication (e.g., 710) to perform a simultaneous multi-beam reception from a network layer for a beam sweeping. In some aspects, 1302 may be performed by sweeping component 199.

At 1304, the network entity may transmit, for the UE, at least one fallback threshold for a deactivation associated with the simultaneous multi-beam reception. For example, the network entity (e.g., 704) may transmit, for the UE, at least one fallback threshold (e.g., 712) for a deactivation associated with the simultaneous multi-beam reception. In some aspects, 1304 may be performed by sweeping component 199.

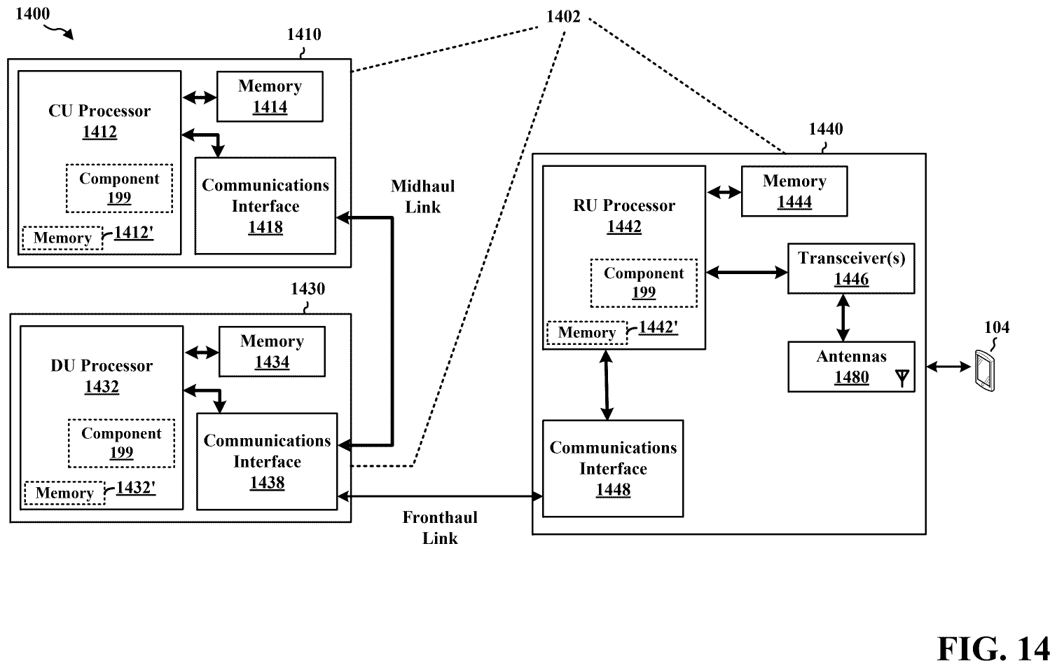

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor 1412. The CU processor(s) 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor 1432. The DU processor(s) 1432 may include on-chip memory 1432′. In some aspects, the DU 1430 may further include additional memory modules 1434 and a communications interface 1438. The DU 1430 communicates with the RU 1440 through a fronthaul link. The RU 1440 may include at least one RU processor 1442. The RU processor(s) 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the sweeping component 199 may be configured to receive, from a UE, an indication to perform a simultaneous multi-beam reception from a network layer for a beam sweeping. In some aspects, the sweeping component 199 may be configured to transmit, for the UE, at least one fallback threshold for a deactivation associated with the simultaneous multi-beam reception. The sweeping component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 may include means for receiving, from a user equipment (UE), an indication to perform a simultaneous multi-beam reception from a network layer for a beam sweeping. In some aspects, the network entity 1402 may include means for transmitting, for the UE, at least one fallback threshold for a deactivation associated with the simultaneous multi-beam reception. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor is configured to perform the set of functions. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor is configured to: transmit, to a network node, an indication to perform a simultaneous multi-beam reception from a network layer for a beam sweeping; receive, from the network node, at least one fallback threshold for a deactivation associated with the simultaneous multi-beam reception; and perform the simultaneous multi-beam reception from the network layer for the beam sweeping.

Aspect 2 is the apparatus of aspect 1, where the at least one processor is further configured to: deactivate the simultaneous multi-beam reception based on the at least one fallback threshold; and perform a fallback procedure after the deactivation associated with the simultaneous multi-beam reception.

Aspect 3 is the apparatus of any of aspects 1-2, where the at least one fallback threshold includes a difference threshold, and where the at least one processor is further configured to: transmit, to the network node based on a difference between a first measurement for a serving cell and a second measurement for a neighbor cell associated with the beam sweeping being above the difference threshold, a request for a fallback procedure after the deactivation associated with the simultaneous multi-beam reception.

Aspect 4 is the apparatus of any of aspects 1-3, where the at least one fallback threshold includes a serving cell threshold, and where the at least one processor is further configured to: transmit, to the network node based on a measurement for a serving cell being above the serving cell threshold, a request for a fallback procedure after the deactivation associated with the simultaneous multi-beam reception.

Aspect 5 is the apparatus of any of aspects 1-4, where the at least one fallback threshold includes a neighbor cell threshold, and where the at least one processor is further configured to: transmit, to the network node based on a measurement for a neighbor cell associated with the beam sweeping being below the neighbor cell threshold, a request for a fallback procedure after the deactivation associated with the simultaneous multi-beam reception.

Aspect 6 is the apparatus of any of aspects 1-5, where the at least one processor is further configured to: transmit, to the network node based on at least one measurement satisfying the at least one fallback threshold, a request for a fallback procedure after the deactivation associated with the simultaneous multi-beam reception; and receive, from the network node, a response to the request for the fallback procedure.

Aspect 7 is the apparatus of aspect 6, where the fallback procedure includes a reduction of a beam sweeping factor, and where the request for the fallback procedure or the response to the request for the fallback procedure includes a value associated with the reduction.

Aspect 8 is the apparatus of any of aspects 6-7, where the fallback procedure includes a skip of a synchronization signal/physical broadcast channel (SS/PBCH) block measurement timing configuration (SMTC).

Aspect 9 is the apparatus of aspect 8, where the at least one processor is further configured to: transmit, to the network node based on the at least one measurement no longer satisfying the at least one fallback threshold, a second request for resuming the simultaneous multi-beam reception from the network layer for the beam sweeping; and receive, from the network node, a second response to the second request.

Aspect 10 is the apparatus of any of aspects 1-9, where the beam sweeping corresponds to a layer 3 (L3) fast beam sweeping.

Aspect 11 is the apparatus of any of aspects 1-10, where the beam sweeping corresponds to a procedure including simultaneous reception of reference signals in different directions associated with a same target cell.

Aspect 12 is the apparatus of any of aspects 1-11, further including at least one of a transceiver or an antenna, where to perform the simultaneous multi-beam reception from the network layer for the beam sweeping, the at least one processor is configured to perform, via at least one of the transceiver or the antenna, the simultaneous multi-beam reception from the network layer for the beam sweeping based on an activation threshold.

Aspect 13 is an apparatus for wireless communication at a network node, including: at least one memory; and at least one processor coupled to the at least one memory, and based at least in part on information stored in the at least one memory, the at least one processor is configured to: receive, from a user equipment (UE), an indication to perform a simultaneous multi-beam reception from a network layer for a beam sweeping; and transmit, for the UE, at least one fallback threshold for a deactivation associated with the simultaneous multi-beam reception.

Aspect 14 is the apparatus of aspect 13, where the at least one fallback threshold includes a difference threshold, and where the at least one processor is further configured to: receive, from the UE based on a difference between a first measurement for a serving cell and a second measurement for a neighbor cell associated with the beam sweeping being above the difference threshold, a request for a fallback procedure after the deactivation associated with the simultaneous multi-beam reception.

Aspect 15 is the apparatus of any of aspects 13-14, where the at least one fallback threshold includes a serving cell threshold, and where the at least one processor is further configured to: receive, from the UE based on a measurement for a serving cell being above the serving cell threshold, a request for a fallback procedure after the deactivation associated with the simultaneous multi-beam reception.

Aspect 16 is the apparatus of any of aspects 13-15, where the at least one fallback threshold includes a neighbor cell threshold, and where the at least one processor is further configured to: receive, from the UE based on a measurement for a neighbor cell associated with the beam sweeping being below the neighbor cell threshold, a request for a fallback procedure after the deactivation associated with the simultaneous multi-beam reception.

Aspect 17 is the apparatus of any of aspects 13-16, where the at least one processor is further configured to: receive, from the UE based on at least one measurement satisfying the at least one fallback threshold, a request for a fallback procedure after the deactivation associated with the simultaneous multi-beam reception; and receive, from the network node, a response to the request for the fallback procedure.

Aspect 18 is the apparatus of aspect 17, where the fallback procedure includes a reduction of a beam sweeping factor, and where the request for the fallback procedure or the response to the request for the fallback procedure includes a value associated with the reduction.

Aspect 19 is the apparatus of any of aspects 17-18, where the fallback procedure includes a skip of a synchronization signal/physical broadcast channel (SS/PBCH) block measurement timing configuration (SMTC).

Aspect 20 is the apparatus of aspect 19, where the at least one processor is further configured to: receive, from the UE based on the at least one measurement no longer satisfying the at least one fallback threshold, a second request for resuming the simultaneous multi-beam reception from the network layer for the beam sweeping; and receive, from the network node, a second response to the second request.

Aspect 21 is the apparatus of any of aspects 13-20, where the beam sweeping corresponds to a layer 3 (L3) fast beam sweeping.

Aspect 22 is the apparatus of any of aspects 13-21, where the beam sweeping corresponds to a procedure including simultaneous reception of reference signals in different directions associated with a same target cell.

Aspect 23 is a method of wireless communication for implementing any of aspects 1 to 12.

Aspect 24 is a computer-readable medium (e.g., a non-transitory computer-readable medium) storing computer executable code, the code when executed by at least one processor causes the at least one processor to implement any of aspects 1 to 12.

Aspect 25 is an apparatus comprising means for implementing any of aspects 1 to 12.

Aspect 26 is a method of wireless communication for implementing any of aspects 13 to 22.

Aspect 27 is a computer-readable medium (e.g., a non-transitory computer-readable medium) storing computer executable code, the code when executed by at least one processor causes the at least one processor to implement any of aspects 13 to 22.

Aspect 28 is an apparatus comprising means for implementing any of aspects 13 to 22.

What is claimed is:

1. An apparatus for wireless communication at a user equipment (UE), including:
at least one memory; and
at least one processor coupled to the at least one memory, and based at least in part on information stored in the at least one memory, the at least one processor is configured to:
transmit, to a network node, an indication to perform a simultaneous multi-beam reception from a network layer for a beam sweeping;
receive, from the network node, at least one fallback threshold for a deactivation associated with the simultaneous multi-beam reception; and
perform the simultaneous multi-beam reception from the network layer for the beam sweeping.

2. The apparatus of claim 1, wherein the at least one processor is further configured to:
deactivate the simultaneous multi-beam reception based on the at least one fallback threshold; and
perform a fallback procedure after the deactivation associated with the simultaneous multi-beam reception.

3. The apparatus of claim 1, wherein the at least one fallback threshold comprises a difference threshold, and wherein the at least one processor is further configured to:
transmit, to the network node based on a difference between a first measurement for a serving cell and a second measurement for a neighbor cell associated with the beam sweeping being above the difference threshold, a request for a fallback procedure after the deactivation associated with the simultaneous multi-beam reception.

4. The apparatus of claim 1, wherein the at least one fallback threshold comprises a serving cell threshold, and wherein the at least one processor is further configured to:
transmit, to the network node based on a measurement for a serving cell being above the serving cell threshold, a request for a fallback procedure after the deactivation associated with the simultaneous multi-beam reception.

5. The apparatus of claim 1, wherein the at least one fallback threshold comprises a neighbor cell threshold, and wherein the at least one processor is further configured to:
transmit, to the network node based on a measurement for a neighbor cell associated with the beam sweeping being below the neighbor cell threshold, a request for a fallback procedure after the deactivation associated with the simultaneous multi-beam reception.

6. The apparatus of claim 1, wherein the at least one processor is further configured to:
transmit, to the network node based on at least one measurement satisfying the at least one fallback threshold, a request for a fallback procedure after the deactivation associated with the simultaneous multi-beam reception; and
receive, from the network node, a response to the request for the fallback procedure.

7. The apparatus of claim 6, wherein the fallback procedure comprises a reduction of a beam sweeping factor, and wherein the request for the fallback procedure or the response to the request for the fallback procedure comprises a value associated with the reduction.

8. The apparatus of claim 6, wherein the fallback procedure comprises a skip of a synchronization signal/physical broadcast channel (SS/PBCH) block measurement timing configuration (SMTC).

9. The apparatus of claim 8, wherein the at least one processor is further configured to:
transmit, to the network node based on the at least one measurement no longer satisfying the at least one fallback threshold, a second request for resuming the simultaneous multi-beam reception from the network layer for the beam sweeping; and
receive, from the network node, a second response to the second request.

10. The apparatus of claim 1, wherein the beam sweeping corresponds to a layer 3 (L3) fast beam sweeping.

11. The apparatus of claim 1, wherein the beam sweeping corresponds to a procedure comprising simultaneous reception of reference signals in different directions associated with a same target cell.

12. The apparatus of claim 1, further comprising at least one of a transceiver or an antenna, wherein to perform the simultaneous multi-beam reception from the network layer for the beam sweeping, the at least one processor is configured to perform, via at least one of the transceiver or the antenna, the simultaneous multi-beam reception from the network layer for the beam sweeping based on an activation threshold.

13. A method for wireless communication performed by a user equipment (UE), including:
transmitting, to a network node, an indication to perform a simultaneous multi-beam reception from a network layer for a beam sweeping;
receiving, from the network node, at least one fallback threshold for a deactivation associated with the simultaneous multi-beam reception; and
performing the simultaneous multi-beam reception from the network layer for the beam sweeping.

14. The method of claim 13, further comprising:
deactivating the simultaneous multi-beam reception based on the at least one fallback threshold; and
performing a fallback procedure after the deactivation associated with the simultaneous multi-beam reception.

15. The method of claim 13, wherein the at least one fallback threshold comprises a difference threshold, and further comprising:
transmitting, to the network node based on a difference between a first measurement for a serving cell and a second measurement for a neighbor cell associated with the beam sweeping being above the difference threshold, a request for a fallback procedure after the deactivation associated with the simultaneous multi-beam reception.

16. The method of claim 13, wherein the at least one fallback threshold comprises a serving cell threshold, and further comprising:
transmitting, to the network node based on a measurement for a serving cell being above the serving cell threshold, a request for a fallback procedure after the deactivation associated with the simultaneous multi-beam reception.

17. The method of claim 13, wherein the at least one fallback threshold comprises a neighbor cell threshold, and further comprising:
transmitting, to the network node based on a measurement for a neighbor cell associated with the beam sweeping being below the neighbor cell threshold, a request for a fallback procedure after the deactivation associated with the simultaneous multi-beam reception.

18. The method of claim 13, further comprising:
transmitting, to the network node based on at least one measurement satisfying the at least one fallback threshold, a request for a fallback procedure after the deactivation associated with the simultaneous multi-beam reception; and
receiving, from the network node, a response to the request for the fallback procedure.

19. The method of claim 18, wherein the fallback procedure comprises a reduction of a beam sweeping factor, and wherein the request for the fallback procedure or the response to the request for the fallback procedure comprises a value associated with the reduction.

20. An apparatus for wireless communication at a network node, including:
at least one memory; and
at least one processor coupled to the at least one memory, and based at least in part on information stored in the at least one memory, the at least one processor is configured to:
receive, from a user equipment (UE), an indication to perform a simultaneous multi-beam reception from a network layer for a beam sweeping; and
transmit, for the UE, at least one fallback threshold for a deactivation associated with the simultaneous multi-beam reception.
